(19) United States
(12) Patent Application Publication
(10) Pub. No.: US 2014/0140673 A1
(43) Pub. Date: May 22, 2014

(54) METHOD OF MANUFACTURING OPTICAL FIBER PREFORM, AND OPTICAL FIBER

(71) Applicant: SUMITOMO ELECTRIC INDUSTRIES, LTD., Osaka (JP)

(72) Inventors: Kazuhiro YONEZAWA, Yokohama-shi (JP); Tadashi ENOMOTO, Yokohama-shi (JP)

(73) Assignee: SUMITOMO ELECTRIC INDUSTRIES, LTD., Osaka (JP)

(21) Appl. No.: 14/065,599

(22) Filed: Oct. 29, 2013

(30) Foreign Application Priority Data
Nov. 16, 2012 (JP) 2012-252438

(51) Int. Cl. C03B 37/014; G02B 6/028; G02B 6/02

(52) U.S. Cl. CPC C03B 37/01446; G02B 6/02; G02B 6/0288
USPC 385/124; 65/413; 385/123

(57) ABSTRACT

The present invention relates to a preform manufacturing method and others for effectively reducing variation in refractive index due to chlorine used in manufacture of an optical fiber preform. The manufacturing method includes a dechlorination step carried out between a point of an end time of a dehydration step and a point of a start time of a sintering step, the dechlorination step being a step of heating a porous preform after dehydrated, in an atmosphere containing no chlorine-based dehydrating agent, for a given length of time while maintaining a temperature lower than a sintering temperature, thereby removing chlorine from the porous preform after dehydrated.

### BACKGROUND OF THE INVENTION

1. Field of the Invention

The present invention relates to a method of manufacturing an optical fiber preform, and an optical fiber obtained by drawing the optical fiber preform manufactured thereby.

2. Related Background Art

An optical fiber used mainly as communication media, particularly a silica-based optical fiber, has been obtained heretofore by manufacturing a preform designed in a desired refractive index profile (which will be referred to hereinafter as optical fiber preform) and drawing this optical fiber preform under predetermined conditions. For example, in the preform manufacturing method described in Japanese Patent Application Laid-Open Publication No. H9-110456 (Patent Literature 1), a porous body (which will be referred to hereinafter as porous preform) for obtaining a preform corresponding to a core region of an optical fiber (which will be referred to hereinafter as core preform) and an optical fiber preform (which is a preform wherein a glass region corresponding to a cladding region is formed on the outer peripheral surface of the core preform) are formed, for example, by the VAD (Vapor phase Axial Deposition) process or by the OVD (Outside Vapor phase Deposition) process. Thereafter, the porous preform thus obtained is heated in a chlorine-based dehydrating agent atmosphere to adequately remove hydroxyl groups (-OH) (dehydration step), and is further heated at high temperature in an inert atmosphere to make a transparent glass body (sintering step).

In the foregoing Patent Literature 1, for speeding up the dehydration and sintering, preliminary sintering, which is a step of continuously increasing heating temperature in a temperature range (from a heating temperature in the dehydration step to a heating temperature in the sintering step) slightly lower than a temperature at which the porous preform starts quickly increasing its density, in a soaking furnace in which the porous preform is set, is carried out prior to the sintering for implementation of formation of the transparent glass body.

### SUMMARY OF THE INVENTION

The Inventors conducted detailed research on the conventional manufacturing method of the optical fiber preform and found the problem as described below.

Namely, chlorine used as the dehydrating agent in the dehydration step in the manufacturing process of optical fiber preform remains in the porous preform even after completion of the dehydration step. This residual chlorine diffuses in an inert atmosphere which is an atmosphere containing no chlorine in the furnace, to be gradually discharged to the outside of the porous preform.

For example, when the sintering step is carried out in a traverse furnace, there is a time difference between a time of completion of the transparent glass body formation on the sintering beginning end side of the porous preform and a time of completion of the transparent glass body formation on the sintering finish end side of the porous preform. Then, there is more residual chlorine on the sintering beginning end side where the sintering is completed earlier, while there is less residual chlorine on the sintering finish end side where the sintering is completed later. On the other hand, when the sintering step is carried out in the soaking furnace, there is also a temperature difference because temperatures to which the porous preform is exposed are not constant in the longitudinal direction thereof in a precise sense. For this reason, the sintering proceeds first from a portion becoming relatively higher in temperature. Therefore, when the porous preform is viewed along the longitudinal direction thereof, a portion where the sintering has proceeded earlier has a higher chlorine concentration, while a portion where the sintering has proceeded later has a lower chlorine concentration.

In general, chlorine is also known as a refractive index increasing agent and, if chlorine is added in silica glass (SiO₂), the silica glass will increase its refractive index according to a chlorine concentration. It was found that, for the above reason, a remaining amount and a distribution of chlorine used originally for the purpose of dehydration varied along the longitudinal direction of the core preform or the optical fiber preform including the core preform, resulting in change in refractive index along the longitudinal direction in the optical fiber obtained finally. Namely, there was the following problem: the variation in chlorine distribution along the longitudinal direction of the optical fiber obtained finally led to the variation along the longitudinal direction in refractive index in the optical fiber, causing destabilization of fiber characteristics and reduction in manufacturing yield.

The present invention has been accomplished to solve the above-described problem and it is an object of the present invention to provide a method of manufacturing an optical fiber preform, which effectively suppresses the occurrence of the unintended refractive index variation along the longitudinal direction of the finally-obtained optical fiber due to chlorine remaining in manufacture of the optical fiber preform, and an optical fiber obtained from the manufactured optical fiber preform.

A manufacturing method of optical fiber preform according to an embodiment of the present invention is to manufacture an optical fiber preform for obtaining an optical fiber composed of silica-based glass (silica-based optical fiber). In order to solve the above problem, the manufacturing method of optical fiber preform according to the present embodiment, as a first aspect, comprises a deposition step to manufacture a porous preform, a dehydration step, and a sintering step and further comprises a dechlorination step of removing or reducing chlorine having intruded into the porous preform in the dehydration step, between a point of an end time of the dehydration step and a point of a start time of the sintering step. The deposition step is to manufacture the porous preform in which at least a peripheral region is covered by a porous glass body. The dehydration step of reducing an OH content of the porous preform is to heat the porous preform manufactured in the deposition step, in an atmosphere containing a chlorine-based dehydrating agent, for a given length of time while maintaining a first temperature. The dechlorination step of removing chlorine from the porous preform after dehydrated through the dehydration step is to heat the porous preform after dehydrated, in an atmosphere containing no chlorine-based dehydrating agent, for a given length of time while maintaining a second temperature. The sintering step of obtaining a transparent glass body from the porous preform after dechlorinated through the dechlorination step is to heat the porous preform after dechlorinated, in an atmosphere containing no chlorine-based dehydrating agent, for a given length of time while maintaining a third temperature higher than both of the first and second temperatures, thereby changing the porous preform after dechlorinated, into the transparent glass body.

Each of the foregoing dehydration step, dechlorination step, and sintering step may be applied to manufacture of a part of the optical fiber preform obtained by the manufacturing method, e.g., a core preform corresponding to a core of an optical fiber to be obtained, or may be applied to manufacture of a portion corresponding to a cladding of an optical fiber to be obtained by depositing a porous glass body on an outer peripheral surface of the core preform.

As a second aspect applicable to the first aspect, the foregoing dehydration step, dechlorination step, and sintering step may be carried out in a traverse furnace which heats the porous preform while continuously moving a heated region from one end to the other end of the porous preform. As a third aspect applicable to the first aspect, the foregoing dehydration step, dechlorination step, and sintering step may be carried out in a soaking furnace which simultaneously heats the whole porous preform.

In the present embodiment, as described above, the dechlorination step of heating the porous preform in an inert atmosphere is carried out between a point of an end time of the dehydration step of heating the porous preform in the atmosphere containing the chlorine-based dehydrating agent and a point of a start time of the sintering step of heating the porous preform in an inert atmosphere. This step results in removing as much chlorine remaining in the porous body, as possible, prior to the start of the sintering step. Namely, it reduces the dispersion of residual chlorine amounts due to the time difference from the sintering start to completion, which occurs in the sintering step (the dispersion of residual chlorine amounts along the longitudinal direction of the transparent glass body after sintered). As a result, the variation in refractive index along the longitudinal direction of the finally-obtained optical fiber (the variation in refractive index due to residual chlorine) is effectively reduced and then we can expect stabilization of optical fiber characteristics and improvement in yield. This effect is expected to be prominent with application of the traverse furnace but is also considered to be adequately achieved even with application of the soaking furnace.

As a fourth aspect applicable to at least any one of the first to third aspects, the preferred second temperature in the dechlorination step is not more than 1300° C. The temperature range over 1300° C. is a range in which the increase in density and sintering of the porous preform begins to progress, and thus hinders the removal of chlorine based on diffusion thereof out of the porous preform. For this reason, the dechlorination step is preferably carried out at 1300° C. or less at which the increase in density is less likely to occur.

Furthermore, an optical fiber according to an embodiment of the present invention is obtained by drawing the optical fiber preform manufactured by the foregoing manufacturing method, as a fifth aspect applicable to at least any one of the above first to fourth aspects. Namely, the optical fiber obtained from the optical fiber preform manufactured by the preform manufacturing method according to the present embodiment shows a more stabilized variation along the longitudinal direction of the optical fiber, in refractive index in the core region and the cladding region, than the conventional optical fiber (optical fiber obtained from the optical fiber preform manufactured by the conventional preform manufacturing method). Therefore, the optical fiber with stable optical characteristics can be manufactured in a high yield.

As a sixth aspect applicable to at least any one of the first to fifth aspects, the optical fiber according to the present embodiment may be a multimode optical fiber with a graded index type refractive index profile (which will be referred to hereinafter as GI type multimode optical fiber). Such a multimode optical fiber is also obtained by drawing the optical fiber preform manufactured by the aforementioned manufacturing method. In general, the GI type multimode optical fiber among the optical fibers used in communication application demonstrates a change of transmission band sensitive to slight variation in refractive index in each glass region, and thus use of the optical fiber preform manufactured by the manufacturing method according to the present embodiment is significantly advantageous.

As a seventh aspect applicable to at least either one of the fifth and sixth aspects, a preferred maximum concentration of chlorine remaining in a core of the optical fiber obtained is not more than 0.15% by weight (a percentage by weight will be referred to hereinafter as wt %). When the maximum concentration of chlorine finally remaining in the core is reduced to not more than 0.15 wt % in this manner, the dispersion of refractive index along the longitudinal direction of the optical fiber due to chlorine remaining in the core can be considerably reduced. Furthermore, as an eighth aspect applicable to at least any one of the fifth to seventh aspects, a variation along a longitudinal direction of the optical fiber, in a maximum concentration of chlorine remaining in a core of the optical fiber is preferably not more than ±0.05 wt %. As a ninth aspect applicable to at least any one of the fifth to eighth aspects, in a concentration distribution along a radial direction of the optical fiber, of chlorine remaining in a core, a difference between a maximum and a minimum thereof is preferably not more than 0.12 wt %.

Each of embodiments according to the present invention can become more fully understood from the detailed description given hereinbelow and the accompanying drawings. These embodiments are presented by way of illustration only, and thus are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, and it is apparent that various modifications and improvements within the scope of the invention would be obvious to those skilled in the art from this detailed description.

### BRIEF DESCRIPTION OF THE DRAWINGS

FIGS. 1A to 1D are drawings showing a sectional structure of an optical fiber according to an embodiment of the present invention, and various refractive index profiles applicable to the optical fiber.

FIGS. 2A and 2B are drawings for explaining a device configuration for carrying out the OVD process and a device configuration for carrying out the VAD process, respectively, which are applied to a manufacturing step of a core preform (first half step in a manufacturing process of optical fiber preform) in the present embodiment, and to a deposition step in a manufacturing process of a peripheral portion of the core preform (second half step in the manufacturing process of optical fiber preform).

FIGS. 3A to 3C are drawings for explaining device configurations (traverse furnace) for carrying out a dehydration step, a dechlorination step, and a sintering step, respectively, in the present embodiment.

FIGS. 4A to 4C are drawings for explaining an intrusion process of chlorine in the dehydration step.

FIG. 5 is a drawing for explaining another device configuration (soaking furnace) for carrying out the dehydration step, dechlorination step, and sintering step in the present embodiment.

FIG. 6 is a drawing showing a structure of a core preform after sintered.

FIG. 7 is a drawing showing chlorine concentrations at respective parts of a core preform after sintered, which was obtained through the conventional preform manufacturing process.

FIG. 8 is a drawing showing chlorine concentrations at respective parts of a core preform after sintered, which was obtained through the preform manufacturing process of the present embodiment.

FIG. 9 is a drawing for explaining a device configuration for carrying out a drawing step of an optical fiber preform obtained.

### DETAILED DESCRIPTION OF THE PREFERRED EMBODIMENTS

Embodiments of the present invention will be described below in detail with reference to the accompanying drawings. The same elements will be denoted by the same reference signs in the description of the drawings, without redundant description.

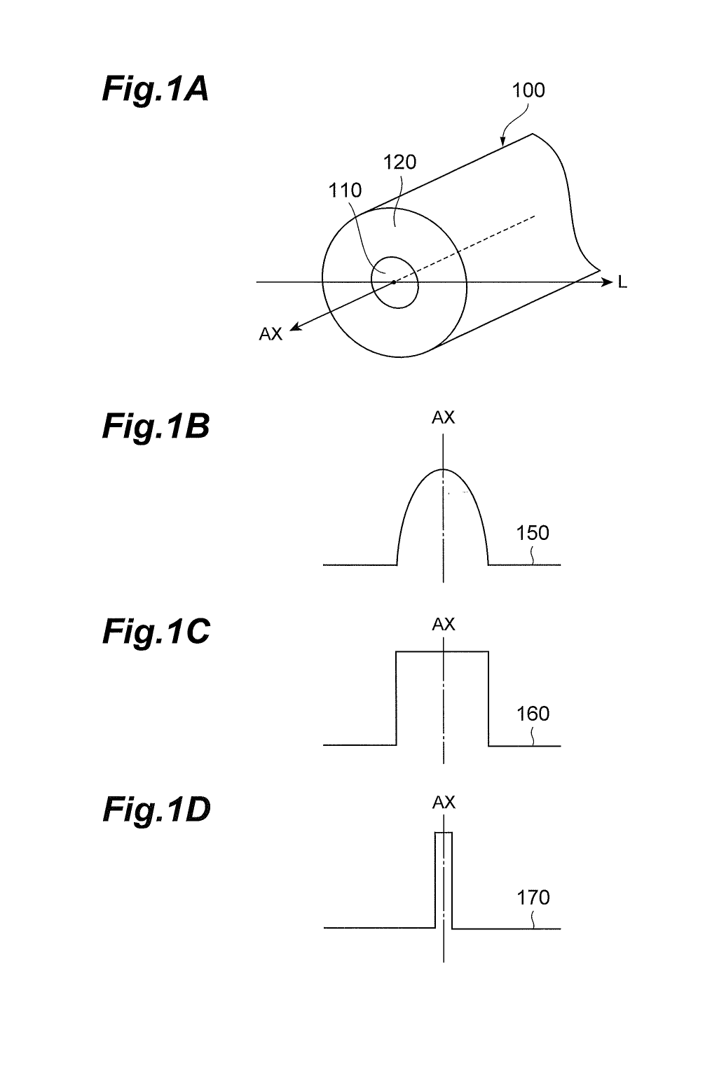

FIGS. 1A to 1D are drawings showing a sectional structure of an optical fiber according to an embodiment of the present invention, and various refractive index profiles applicable to the optical fiber. Specifically, FIG. 1A is a drawing showing the typical sectional structure of the optical fiber according to the present embodiment, and this optical fiber 100 has at least a core region 110 extending along a predetermined axis (coincident with the optical axis AX), and a cladding region 120 provided on the outer periphery of the core region 110. The core region 110 and the cladding region 120 may be comprised of respective glass regions with different refractive indices.

FIGS. 1B to 1D show examples of various refractive index profiles of optical fibers applicable to the optical fiber 100 shown in FIG. 1A. Namely, the optical fiber 100 to be applied herein can be a multimode optical fiber having a GI type refractive index profile 150 shown in FIG. 1B, a multimode optical fiber having a step index type refractive index profile 160 shown in FIG. 1C, or a single-mode optical fiber suitable for long-haul optical communication, having a step type refractive index profile 170 shown in FIG. 1D. The refractive index profiles 150 to 170 shown in FIGS. 1B to 1D indicate refractive indices of respective portions on a line L (coinciding with a radial direction of the optical fiber 100) perpendicular to the optical axis AX coincident with a center of the core region 110, in FIG. 1A.

A manufacturing method of an optical fiber preform, for obtaining the optical fiber 100 having the sectional shape and refractive index profile as described above, will be described below in detail.

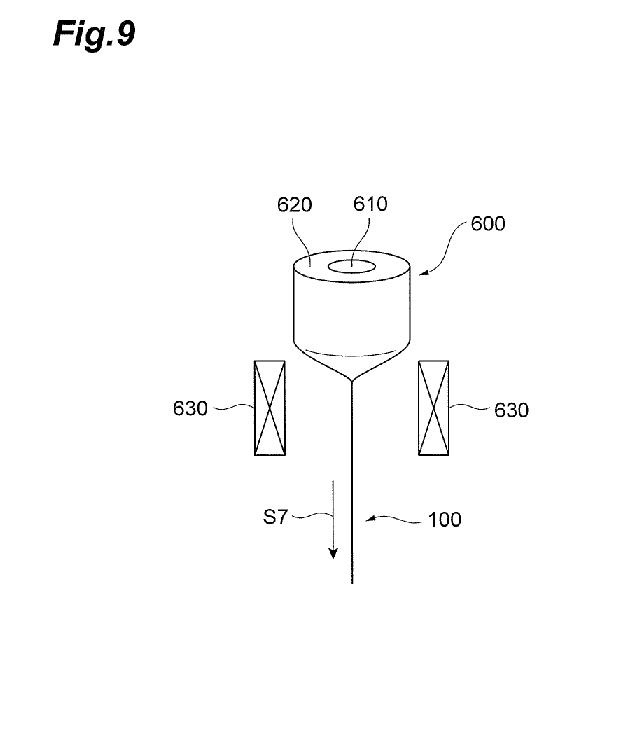

For obtaining the optical fiber 100, an optical fiber preform 600 (cf. FIG. 9) is first manufactured. This optical fiber preform 600 is obtained by initially manufacturing a core preform corresponding to the core region 110 and thereafter further providing a transparent glass body corresponding to the cladding region 120 on the outer periphery of the core preform. In the present embodiment, the core preform is obtained by manufacturing a porous preform, for example, doped with GeO₂ (germanium dioxide) by the OVD process or by the VAD process and subjecting the porous preform to steps including dehydration, dechlorination, sintering, and extension. Furthermore, a porous glass body is deposited on the outer periphery of the obtained core preform by the VAD process or the like, and the resulting body is processed through the same steps of dehydration, sintering, and others as those described above, to obtain an optical fiber preform in which a transparent glass body corresponding to the cladding region 120 is provided on the outer peripheral surface of the core preform.

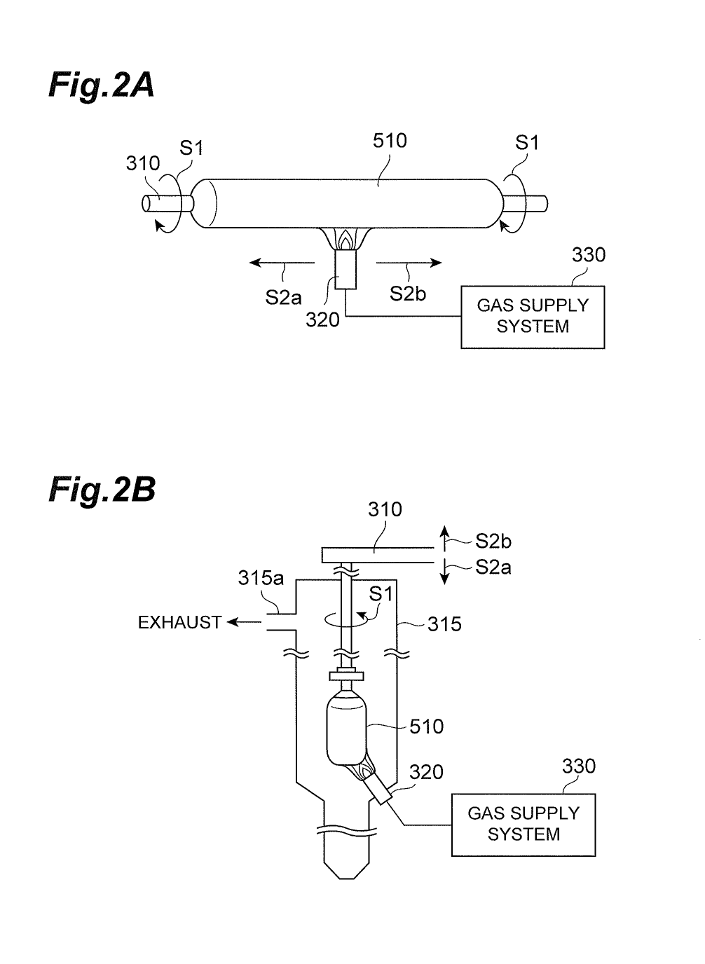

FIG. 2A shows a device configuration for carrying out the OVD process applied to the manufacturing step of the core preform corresponding to the core region 110 of the optical fiber 100 (the first half step in the manufacturing process of the optical fiber preform). FIG. 2B is a drawing for explaining a device configuration for carrying out the VAD process. As an example, where the optical fiber 100 having the GI type refractive index profile 150 is manufactured, the core preform manufactured by the OVD process or by the VAD process is a portion to make the core region 110 with the refractive index profile having the alpha value in the range of 1.9 to 2.2 after drawn.

First, when the OVD process is applied to the deposition step of manufacturing the porous preform wherein at least its peripheral region is covered by a porous glass body, a porous preform 510 is manufactured by a soot-depositing device shown in FIG. 2A. This soot-depositing device has a structure for holding a central shaft 310 (which functions as a support mechanism and which may be a hollow glass tube) in a rotatable state in the direction indicated by arrows S1. The soot-depositing device is provided with a burner 320 for growing the porous preform 510 along the central shaft 310 (support mechanism), and a gas supply system 330 for supplying a source gas. The burner 320 can be moved in directions indicated by arrows S2a and S2b in FIG. 2A, by a predetermined moving mechanism.

During the manufacture of the porous preform 510, fine glass particles are made by hydrolysis reaction of the source gas supplied from the gas supply system 330, in flame of the burner 320, and these fine glass particles are deposited on the side face of the central shaft 310. During this step, the central shaft 310 is rotated in the direction indicated by arrows S1, while the burner 320 is moved in the directions indicated by arrows S2a, S2b. This operation causes a porous glass body to grow along the central shaft 310, obtaining the porous preform 510 (soot preform) to make the core region 110. The soot-depositing device shown in FIG. 2A can also be applied to manufacture of a porous glass body to make the cladding region 120, which is to be formed on the outer peripheral surface of the core preform obtained in the end.

On the other hand, when the VAD process is applied to the deposition step of manufacturing the porous preform wherein at least the peripheral region is covered by the porous glass body, the porous preform 510 (porous glass body) is formed by the soot-depositing device shown in FIG. 2B. This soot-depositing device is provided with a vessel 315 having at least an exhaust port 315a, and a support mechanism 310 for supporting the porous preform 510. Namely, the support mechanism 310 is provided with a support shaft rotatable in the direction indicated by arrow S1, and a starting rod for growth of a porous glass body (soot body) to make the porous preform 510 is attached to the tip of the support shaft.

The soot-depositing device in FIG. 2B is provided with a burner 320 for depositing the porous glass body (soot body), and the gas supply system 330 supplies a desired source gas (e.g., GeCl₄, SiCl₄, etc.), a combustion gas (H₂ and O₂), and a carrier gas such as Ar or He.

During the manufacture of the porous preform 510, fine glass particles are made by hydrolysis reaction of the source gas supplied from the gas supply system 330, in flame of the burner 320, and these fine glass particles are deposited on the bottom surface of the starting rod. During this step, the support mechanism 310 performs an operation of once moving the starting rod disposed at the tip of the support mechanism, in the direction indicated by arrow S2a, and thereafter pulling up the starting rod along the direction indicated by arrow S2b (the longitudinal direction of the porous preform 510) while rotating it in the direction indicated by arrow S1. This operation causes the porous glass body to grow downward from the starting rod on the bottom surface of the starting rod, obtaining the porous preform (soot preform) 510 to make the core region 110 eventually. The soot-depositing device shown in FIG. 2B can also be applied to manufacture of the porous glass body to make the cladding region 120, which is to be formed on the outer peripheral surface of the core preform obtained in the end.

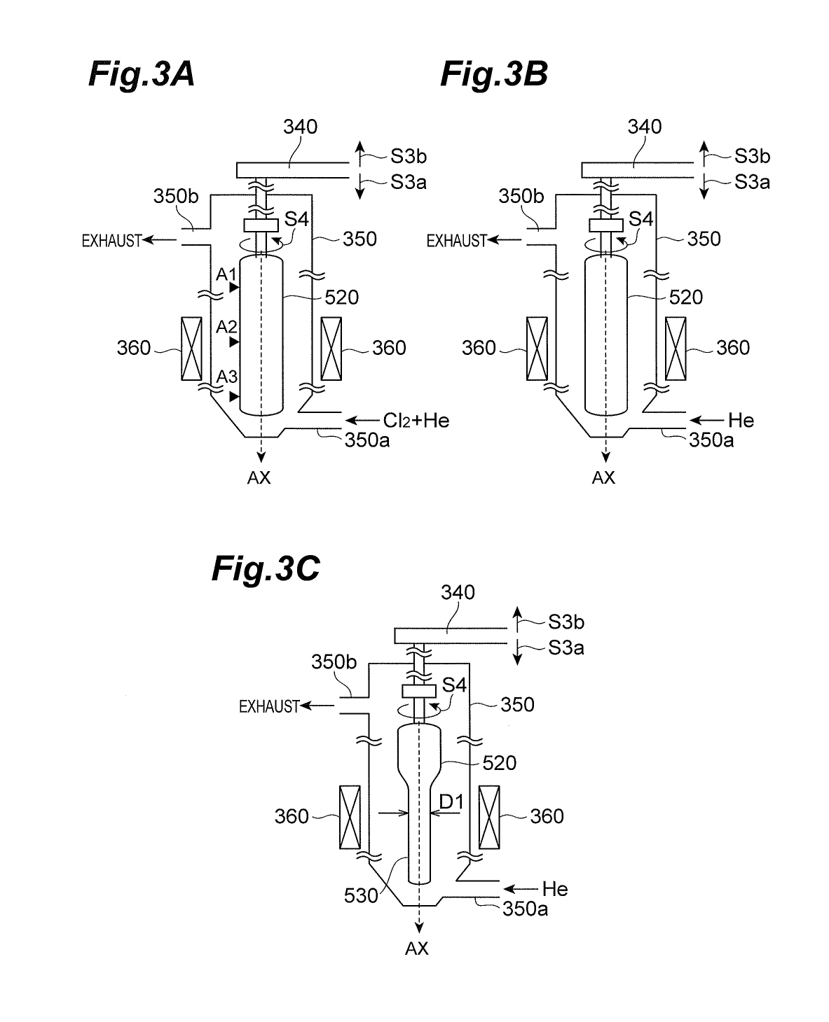

Next, the dehydration step, dechlorination step, and sintering step are successively carried out for the porous preform 510 obtained as described above. FIGS. 3A to 3C are drawings for explaining device configurations for carrying out the dehydration step, the dechlorination step, and the sintering step, respectively, in the present embodiment.

First, the porous preform 510 is manufactured by the OVD process or by the VAD process as described above (deposition step), and then the porous preform 510 is subjected to the dehydration step by the device shown in FIG. 3A. Namely, the porous preform 510 thus manufactured is set in a heating vessel 350 (traverse furnace) with a heater 360, which is shown in FIG. 3A, and is heated in a chlorine-containing atmosphere in a state in which the in-furnace temperature is maintained at a predetermined temperature, for a given length of time. In the case where the porous preform 510 is manufactured by the OVD process, the central shaft 310 is removed from the porous preform 510 before execution of the dehydration step; when the central shaft 310 is a hollow glass tube, it may be removed by flowing an etchant gas into the hollow glass tube after the sintering step.

The heating vessel 350 is provided with an inlet port 350a for supplying a gas containing chlorine and an exhaust port 350b. During this dehydration step, while rotating the porous preform 510 in the direction indicated by arrow S4 around the central axis AX of the porous preform 510 (coincident with the optical axis of the optical fiber to be obtained), the support mechanism 340 further moves the whole porous preform 510 in the directions indicated by arrows S3a, S3b, thereby to change the relative position of the porous preform 510 to the heater 360. Through this step, hydroxyl groups (—OH) are removed to make the porous preform 520 in which a predetermined amount of chlorine is added.

In the dehydration step in the present embodiment, the temperature in the heating furnace 350 is maintained at 1000° C. and a gas mixture containing chlorine gas (Cl₂) at a mixture ratio of 8.5% and He gas at a mixture ratio of 91.5% is supplied through the inlet port 350a into the heating vessel 350. As a result, we obtain the porous preform 520 inside which the predetermined amount of chlorine remains. Each value of the above-described gasses is merely an example of a mixture ratio. Also, a combination of Cl₂ and Ar, a combination of Cl₂ and N₂, and so on is applicable to a gas mixture to be supplied.

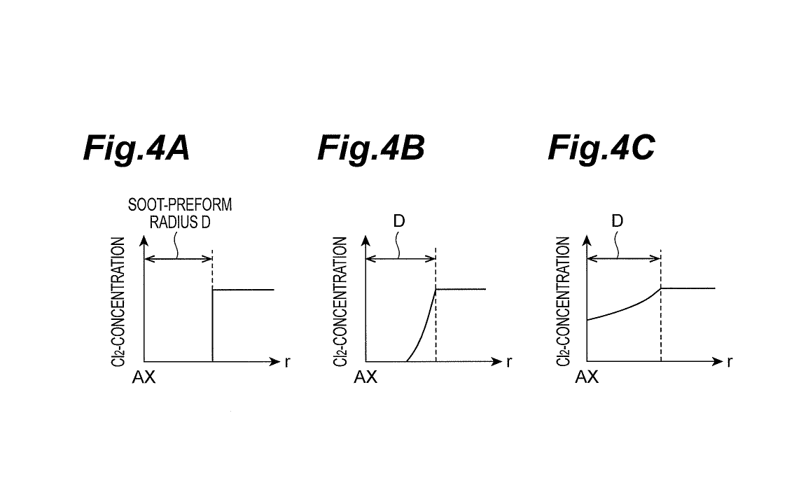

FIGS. 4A to 4C show an intrusion process of chlorine into the porous preform 510. At the beginning of dehydration, no chlorine intrudes into the porous preform 510, as shown in FIG. 4A, at each of parts of the preform indicated by arrows A1 to A3 in FIG. 3A. However, with progress of dehydration, chlorine gradually intrudes in directions toward the center (central axis AX) of the porous preform 510 as a target of dehydration. In the porous preform 520 at a point of an end time of the dehydration step, i.e., in the porous preform 520 after the dehydration, a considerable amount of chlorine remains. In FIGS. 4A to 4C, the axis of abscissas represents the radial distance r from the central axis AX of the porous preform 510 (520), and the axis of ordinates the chlorine concentration.

Subsequently, in the present embodiment, the porous preform 520 after dehydrated is subjected to the dechlorination step by the device shown in FIG. 3B. Namely, the porous preform 520 after dehydrated is set in the heating vessel 350 (traverse furnace) with the heater 360 shown in FIG. 3B, and is heated in an atmosphere not containing chlorine (e.g., in an inert gas), in a state in which the interior of the furnace is maintained at a predetermined temperature of not more than 1300° C., for a given length of time.

The heating vessel 350 shown in FIG. 3B is also provided with the inlet port 350a for supplying a gas not containing chlorine (e.g., He gas, N₂ gas, Ar gas, a gas mixture of He and Ar, a gas mixture of He and N₂, and so on), and the exhaust port 350b. During this dechlorination step, while rotating the porous preform 520 after dehydrated, in the direction indicated by arrow S4 around the central axis of the porous preform 520, the support mechanism 340 further moves the whole porous preform 520 in the directions indicated by arrows S3a, S3b, thereby to change the relative position of the porous preform 520 to the heater 360. Through this step, the chlorine having remained in the porous preform 520 after dehydrated is removed.

In the dechlorination step in the present embodiment, the temperature in the heating furnace 350 is maintained at 1000° C. (in-furnace temperature) which is the same as in the dehydration step, and a gas containing only He is supplied through the inlet port 350a into the heating vessel 350, thereby to remove the chlorine having remained in the porous preform 520 after dehydrated. The preferred temperature in the dechlorination step is not more than 1300° C. The temperature range over 1300° C. is a range in which the increase in density and sintering of porous glass begins to proceed, and the progress of the density increase and sintering will impede the removal of chlorine based on the diffusion thereof out of the porous glass.

The porous preform 520 after dechlorinated, which was obtained through the foregoing dechlorination step, is then sintered in the heating vessel 350 shown in FIG. 3C (to be transparentized). Namely, as shown in FIG. 3C, the porous preform 520 after dechlorinated is set in the heating vessel 350 (traverse furnace) in a state in which it is supported by the support mechanism 340. At this time, the temperature in the heating vessel 350 (in-furnace temperature) is maintained at 1500° C. higher than the temperature at which the dechlorination step is executed, and He gas is supplied through the inlet port 350a into the heating vessel 350. The gas to be supplied into the heating vessel 350 is not limited to He gas. Instead of He gas, N₂ gas, Ar gas, a gas mixture of He and at least either one of these gasses, or the like may be used as a gas to be supplied into the heating vessel.

During this sintering step, while rotating the porous preform 520 after dechlorinated, in the direction indicated by arrow S4 around the central axis of the porous preform 520, the support mechanism 340 further moves the whole porous preform 520 in the directions indicated by arrows S3a, S3b, thereby to change the relative position of the porous preform 520 to the heater 360. Through this step, we obtain a transparent glass body 530 with the diameter D1.

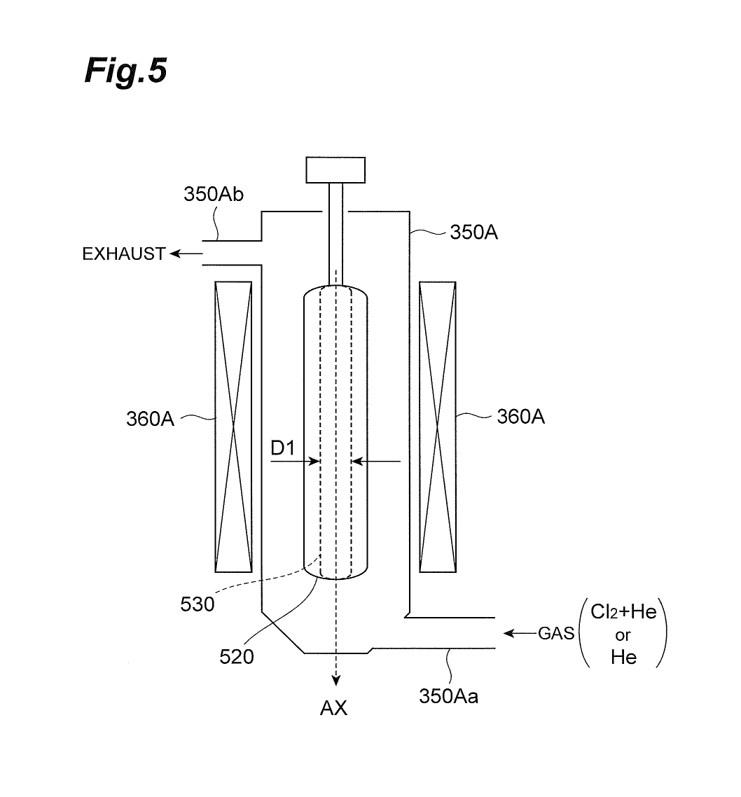

The foregoing dehydration step, dechlorination step, and sintering step were executed in the traverse furnace (heating vessel 350), but each of these steps may be executed in a heating vessel 350A (soaking furnace) shown in FIG. 5. FIG. 5 is a drawing for explaining another device configuration (soaking furnace) for carrying out the dehydration step, the dechlorination step, and the sintering step in the present embodiment.

In FIG. 5, the heating vessel 350A as a soaking furnace is provided with an inlet port 350Aa for supply of gas and an exhaust port 350Ab, as in the aforementioned traverse furnace, and the heating vessel 350A is further provided with a heater 360A to simultaneously heat the whole porous preform set in the heating vessel 350A. In each of the steps of dehydration, dechlorination, and sintering with application of this heating vessel 350A as a soaking furnace, the conditions including the supply gas, the heating temperature, and so on are the same as those with application of the heating vessel 350 as a traverse furnace shown in FIGS. 3A to 3C.

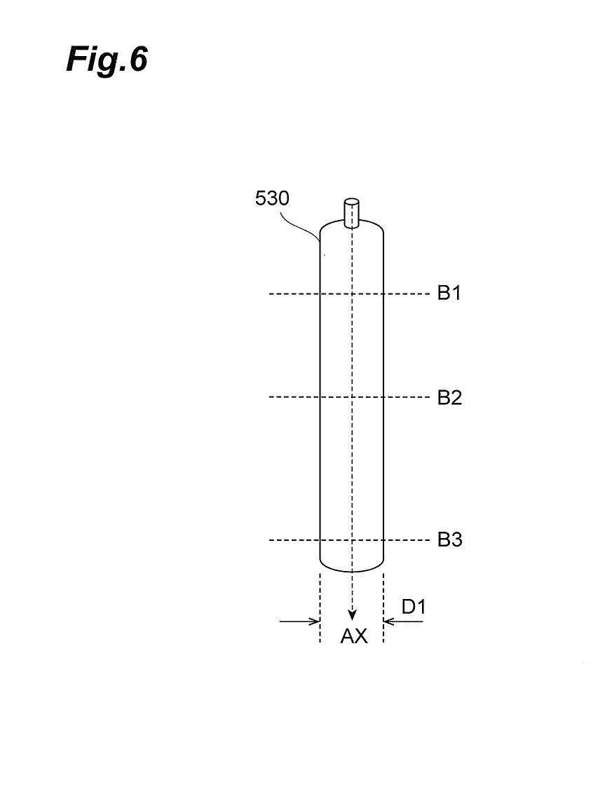

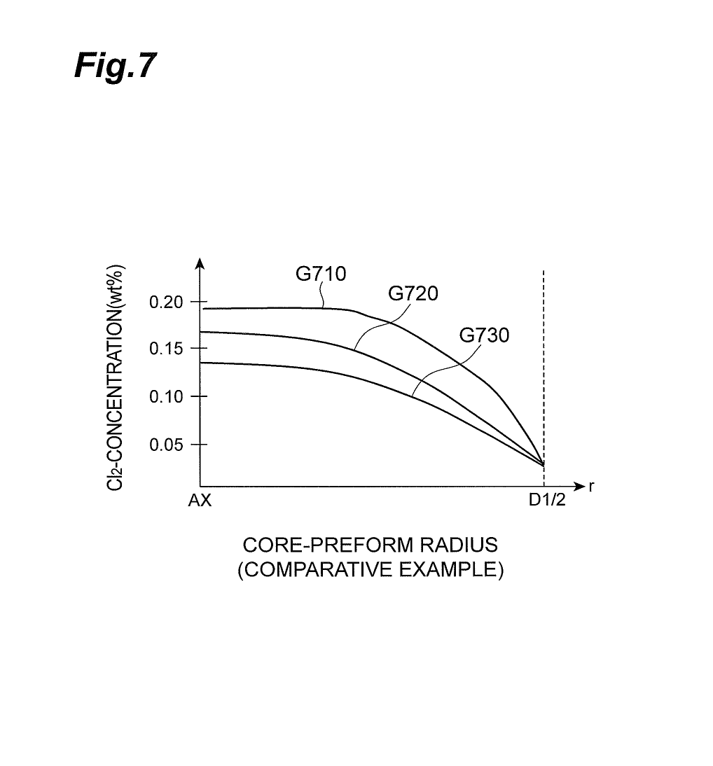

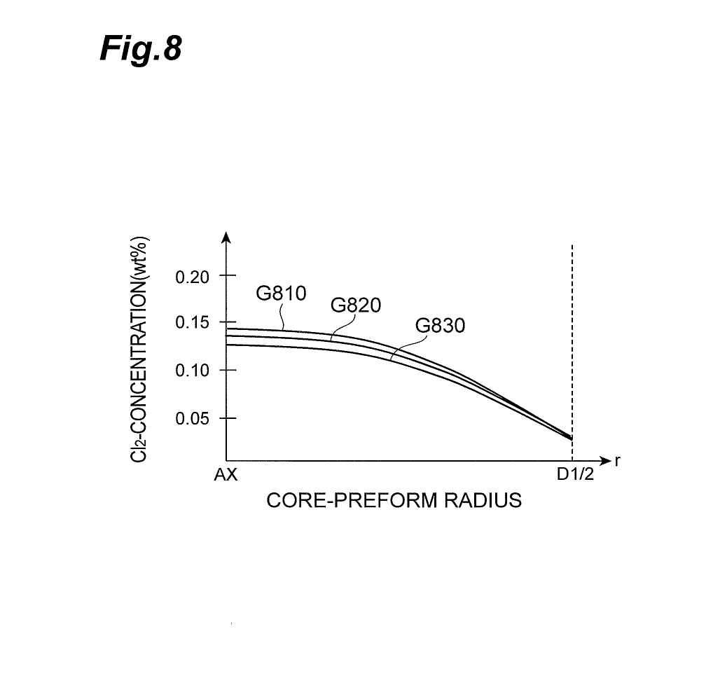

Next, FIG. 6 shows the structure of the transparent glass body 530 (core preform before extension or unextended core preform) obtained through the aforementioned dehydration step, dechlorination step, and sintering step. FIG. 8 shows the results of measurement of residual chlorine at respective parts of the unextended core preform 530. FIG. 7 is a drawing showing chlorine concentrations at respective parts of the core preform after sintered, which was obtained through the conventional preform manufacturing process, as a comparative example.

In the conventional preform manufacturing method, the dehydration step and the sintering step are successively carried out for the porous preform manufactured in the deposition step. These steps are carried out by the same devices as those shown in FIGS. 3A and 3C, respectively. Namely, in the dehydration step in the conventional technology, the in-furnace temperature is maintained at 1000° C. and the gas mixture containing chlorine gas (Cl₂) at the mixture ratio of 8.5% and He gas at the mixture ratio of 91.5% is supplied through the inlet port into the heating vessel. Thereafter, the in-furnace temperature is immediately raised from 1000° C. to 1500° C. and then the sintering step is carried out in a 100% He gas atmosphere. FIG. 7 is the drawing showing changes of residual chlorine concentrations along the radial direction r at the respective parts of the core preform obtained by the above-described conventional preform manufacturing method (which correspond to parts B1 to B3 of the unextended core preform shown in FIG. 6). Namely, in FIG. 7, graph G710 represents the residual chlorine concentrations at the sintering beginning end side B3 of the core preform, graph G720 the residual chlorine concentrations at an intermediate part B2 of the core preform, and graph G730 the residual chlorine concentrations at the sintering finish end side B1 of the core preform.

On the other hand, in the preform manufacturing method according to the present embodiment, the dehydration step, the dechlorination step, and the sintering step are successively carried out for the porous preform manufactured in the deposition step. Namely, in the dehydration step in the present embodiment, the in-furnace temperature is maintained at 1000° C. and the gas mixture containing chlorine gas (Cl₂) at the mixture ratio of 8.5% and He gas at the mixture ratio of 91.5% is supplied through the inlet port 350a into the heating vessel 350. In the dechlorination step, He gas (100% He gas atmosphere not containing chlorine) is supplied in the state in which the in-furnace temperature is maintained at 1000° C., into the heating vessel 350 in which the porous preform after dehydrated is set. Thereafter, the in-furnace temperature is raised from the in-furnace temperature in the dechlorination step to 1500° C. and then the sintering step is carried out in the 100% He gas atmosphere. FIG. 8 is a drawing showing changes of residual chlorine concentrations along the radial direction r at the respective parts of the core preform obtained by the preform manufacturing method of the present embodiment as described above (which correspond to the parts B1 to B3 of the unextended core preform 530 shown in FIG. 6). Namely, in FIG. 8, graph G810 represents the residual chlorine concentrations at the sintering beginning end side B3 of the unextended core preform 530, graph G820 the residual chlorine concentrations at the intermediate part B2 of the unextended core preform 530, and graph G830 represents the residual chlorine concentrations at the sintering finish end side B1 of the unextended core preform 530.

It is seen from FIGS. 7 and 8 that concentration differences between residual chlorine at the sintering beginning end side B3 and residual chlorine at the sintering finish end side B1, i.e., concentration differences of residual chlorine due to the time difference during the sintering are smaller in the unextended core preform 530 (FIG. 8) obtained by the preform manufacturing method according to the present embodiment. In other words, the dispersion of the chlorine concentration distribution along the longitudinal direction (direction along the central axis AX) is more suppressed in the unextended core preform 530 (FIG. 8) obtained by the preform manufacturing method of the present embodiment than in the unextended core preform (FIG. 7) obtained by the conventional preform manufacturing method. Specifically, in the residual chlorine concentration distribution shown in FIG. 8, a maximum concentration of residual chlorine in the unextended core preform 530 is not more than 0.15 wt %. Furthermore, a variation along the longitudinal direction of the unextended core preform 530, of the maximum concentration of residual chlorine in the unextended core preform 530 (a difference between graph G810 and graph G830 at the central axis AX coincident with the core center) falls within not more than +0.05 wt % with respect to the residual chlorine concentration at any part on the central axis AX. Moreover, a difference between a maximum and a minimum of residual chlorine concentrations in the unextended core preform 530, along the radial direction of the unextended core preform 530 (or the direction perpendicular to the central axis AX) is not more than 0.12 wt % at any part on the central axis AX (in all of graphs G810 to G830, the difference between the maximum and the minimum thereof is not more than 0.12 wt %). Therefore, the shape of the residual chlorine concentration distribution shown in FIG. 8 is also almost maintained in an optical fiber obtained by drawing the optical fiber preform including the pertinent unextended core preform 530, and it is thus contemplated that it is feasible to suppress the unintended refractive index variation (refractive index variation due to residual chlorine) along the longitudinal direction at least in the core region 110.

Subsequently, in order to finally obtain the optical fiber preform 600 as shown in FIG. 9, a porous glass body (preform region to make the cladding region 120 after drawing) is further deposited on the outer peripheral surface of the core preform obtained by extending the transparent glass body 530, thereby manufacturing a new starting preform (second deposition step). This second deposition step can be carried out by either of the OVD process and the VAD process as described above. FIG. 9 is a drawing for explaining a device configuration for carrying out a drawing step of the optical fiber preform obtained.

The dehydration step (FIG. 3A) and the sintering step (FIG. 3C) are again carried out for the porous preform obtained through the second deposition step. Then, the optical fiber preform 600 obtained through the above steps has an inside region 610 to make the core region 110 after drawing and a peripheral region 620 to make the cladding region 120, as shown in FIG. 9. In the fiber drawing step shown in FIG. 9, one end of the optical fiber preform 600 is drawn in the direction indicated by arrow S7, while heated by a heater 630, to obtain the optical fiber 100 having the sectional structure shown in FIG. 1A.

Since the unintended refractive index variation along the longitudinal direction, i.e., the refractive index variation due to the chlorine having remained in the preform manufacture, is removed or reduced in the optical fiber 100 manufactured as described above, the optical fiber 100 has stable fiber characteristics and the manufacture yield thereof can also be improved.

According to the present invention, the manufacture of the optical fiber preform includes the step of heating the porous preform at the temperature lower than the sintering temperature to remove the chlorine having remained in the porous preform, prior to the step of sintering the porous preform dehydrated in the chlorine-containing atmosphere, and therefore, the unintended refractive index variation (refractive index variation due to residual chlorine) along the longitudinal direction of the optical fiber obtained finally is effectively reduced and we can expect the stabilization of fiber characteristics and the improvement in manufacture yield.

From the above description of the present invention, it will be obvious that the invention may be varied in many ways. Such variations are not to be regarded as a departure from the spirit and scope of the present invention, and all improvements as would be obvious to those skilled in the art are intended for inclusion within the scope of the following claims.

What is claimed is:

1. A method of manufacturing an optical fiber preform for obtaining an optical fiber composed of silica-based glass, the method comprising:
a deposition step of manufacturing a porous preform in which at least a peripheral region is covered by a porous glass body;
a dehydration step of reducing an OH content of the porous preform, the dehydration step being a step of heating the porous preform in an atmosphere containing a chlorine-based dehydrating agent, for a given length of time while maintaining a first temperature;
a dechlorination step of removing chlorine from the porous preform after dehydrated through the dehydration step, the dechlorination step being a step of heating the porous preform after dehydrated, in an atmosphere containing no chlorine-based dehydrating agent, for a given length of time while maintaining a second temperature; and
a sintering step of obtaining a transparent glass body from the porous preform after dechlorinated through the dechlorination step, the sintering step being a step of heating the porous preform after dechlorinated, in an atmosphere containing no chlorine-based dehydrating agent, for a given length of time while maintaining a third temperature higher than both of the first and second temperatures, thereby changing the porous preform after dechlorinated, into the transparent glass body.

2. The method according to claim 1, wherein the dehydration step, the dechlorination step, and the sintering step are carried out in a traverse furnace.

3. The method according to claim 1, wherein the dehydration step, the dechlorination step, and the sintering step are carried out in a soaking furnace.

4. The method according to claim 1, wherein the second temperature being the heating temperature in the dechlorination step is not more than 1300° C.

5. An optical fiber obtained by drawing the optical fiber preform manufactured by the method defined in claim 1.

6. The optical fiber according to claim 5, the optical fiber comprising a multimode optical fiber having a graded index type refractive index profile.

7. The optical fiber according to claim 5, wherein a maximum concentration of chlorine remaining in a core of the optical fiber is not more than 0.15 wt %.

8. The optical fiber according to claim 5, wherein a variation along a longitudinal direction of the optical fiber, in a maximum concentration of chlorine remaining in a core of the optical fiber is not more than ±0.05 wt %.

9. The optical fiber according to claim 5, wherein in a concentration distribution along a radial direction of the optical fiber, of chlorine remaining in a core of the optical fiber, a difference between a maximum and a minimum thereof is not more than 0.12 wt %.
